(19) United States
(12) Patent Application Publication
(10) Pub. No.: US 2004/0147232 A1
(43) Pub. Date: Jul. 29, 2004

(54) Wall mounted wireless transceiver that tracks a location of a wireless communication device

(76) Inventor: Richard Zodnik, San Juan Capistrano, CA (US)

Correspondence Address: IRELL & MANELLA LLP, 840 NEWPORT CENTER DRIVE, SUITE 400, NEWPORT BEACH, CA, 92660, US

(21) Appl. No.: 10/672,154

(22) Filed: Sep. 26, 2003

Related U.S. Application Data
(63) Continuation-in-part of application No. 10/122,274, filed on Apr. 11, 2002.
(60) Provisional application No. 60/415,440, filed on Oct. 1, 2002.

(51) Int. Cl. H04B 1/38; H04M 1/00; H04M 11/04

(52) U.S. Cl. 455/90.1; 455/456.1; 379/45; 379/40

(57) ABSTRACT

A locator that is mounted to, or integrated into, an outlet box. The outlet box is mounted to a wall that has a physical address. The locator contains a stored locator address that corresponds to the physical address of the box. The locator can receive a wireless communication from a wireless communication location device such as a cell phone. The communication includes a device identification for the wireless device. The locator transmits the stored locator address and the device identification to a server. The server contains a relational database that correlates the device identification with the physical address. The database provides location information that allows a 9-1-1 operator to locate a caller who is placing a 9-1-1 call through the wireless device.

### REFERENCE TO CROSS-RELATED APPLICATIONS

This application claims priority to Application No. 60/415,440 filed on Oct. 1, 2002 and is a continuation-in-part of application Ser. No. 10/122,274 filed on Apr. 11, 2002, pending.

### BACKGROUND OF THE INVENTION

1. Field of the Invention

The subject matter disclosed relates to a locator that can track the exact physical location of a wireless communication device such as a cellular phone.

2. Background Information

Cellular phones have become a common means of voice communication. Unlike land based systems cell phones allow the user to initiate/receive a call from almost any location.

The United States has a network of emergency operators that handle 9-1-1 emergency phone calls. The emergency network allows a user to place an emergency call to the police, fire station, hospital, etc. in the event of an emergency. For various reasons the caller may not be able to convey their physical location. Without being able to automatically identify the exact physical location of the caller the emergency service may not be able to respond to the call. For calls placed in a land based phone systems the 9-1-1 operators may be able to track the source of the call and determine the physical location of the caller. This can be done by tracing the call through the various switches of the public telephone network.

The mobile nature of cell phones makes it difficult to track the physical location of a caller who cannot communicate their location. The Federal Communications Commission (“FCC”) has mandated that cell phone providers provide a system to identify the physical location of a 9-1-1 caller within a certain accuracy. Although a typical cell phone network can identify the location of a caller within a certain cell of the network, this information is typically not accurate enough to truly locate the caller, and does not meet the FCC requirements.

There have been various attempts to employ technology that will locate a cell phone caller within the mandates dictated by the FCC. One common approach is to implement a global positioning satellite (“GPS”) tracking device within the phone. GPS tracking devices tend to be inaccurate when the caller is located within a building structure. The structure tends to interfere and distort the signals used in the GPS system. Additionally, GPS tracking systems cannot provide three dimensional location information. For example, a GPS tracking device cannot typically distinguish between the different floors of a multi-story building. The system will merely identify the location of the building and not provide the specific floor the caller is on. It would be desirable to provide a system that will accurately identify the exact floor and spatial location of a cell phone caller within a building structure.

### BRIEF SUMMARY OF THE INVENTION

A locator that is mounted to, or integrated into, an outlet box. The outlet box is mounted to a wall that has a physical address. The locator contains a stored locator address that corresponds to the physical address of the box. The locator can receive a wireless communication from a wireless communication device. The communication includes a device identification for the wireless device. The locator transmits the stored locator address and the device identification to a server. The server contains a relational database that correlates the device identification to the physical address.

### BRIEF DESCRIPTION OF THE DRAWINGS

FIG. 1 is a schematic of a locator system for locating a wireless communication device;

FIG. 2 is a schematic showing different cells of the system;

FIG. 3 is an illustration of a locator that can be attached to an outlet box;

FIG. 4 is a schematic of a locator;

FIG. 5 is an illustration of a locator integrated into an outlet box;

FIG. 6 is a diagram showing a relational database of the system.

### DETAILED DESCRIPTION

A locator that is mounted to, or integrated into, an outlet box. The outlet box is mounted to a wall that has a physical address. The locator contains a stored locator address that corresponds to the physical address of the box. The locator can receive a wireless communication from a wireless communication device such as a cell phone. The communication includes a device location identification for the wireless device. The locator transmits the stored locator address and the device identification to a server. The server contains a relational database that correlates the device identification with the physical address. The database provides location information that allows a 9-1-1 operator to locate a caller who is placing a 9-1-1 call through the wireless device.

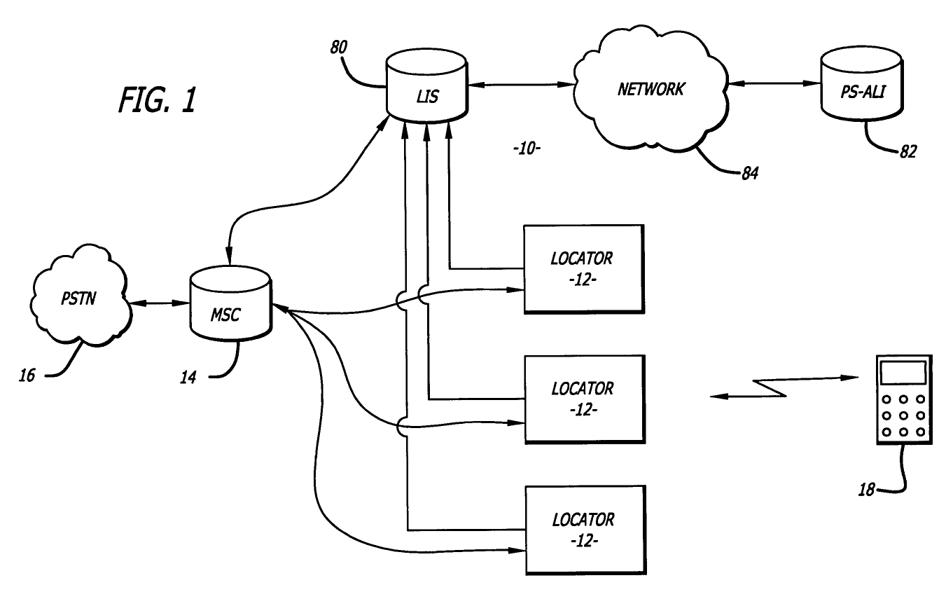

Referring to the drawings more particularly by reference numbers, FIG. 1 discloses a locator system 10 that includes a plurality of locators 12 that function as transceivers for cellular phone communication. The locators 12 are coupled to a mobile switching center (“MSC”) 14 and a public switched telephone network (“PSTN”) 16. The locators 12 are wirelessly coupled to a handset 18. The locators 12 and handset 18 can operate in accordance with standard cellular operation procedures as defined by EIA or TIA Standard 533, which defines the specifications for cellular systems. By way of example, the locators 12 and handset 18 may operate with GSM, TDMA or CDMA protocols. Although a cellular phone is described, device 18 may be any wireless communication device and may operate in accordance with other standards such as I.E.E.E. 802.11. The locator 12 would also operate in such standards.

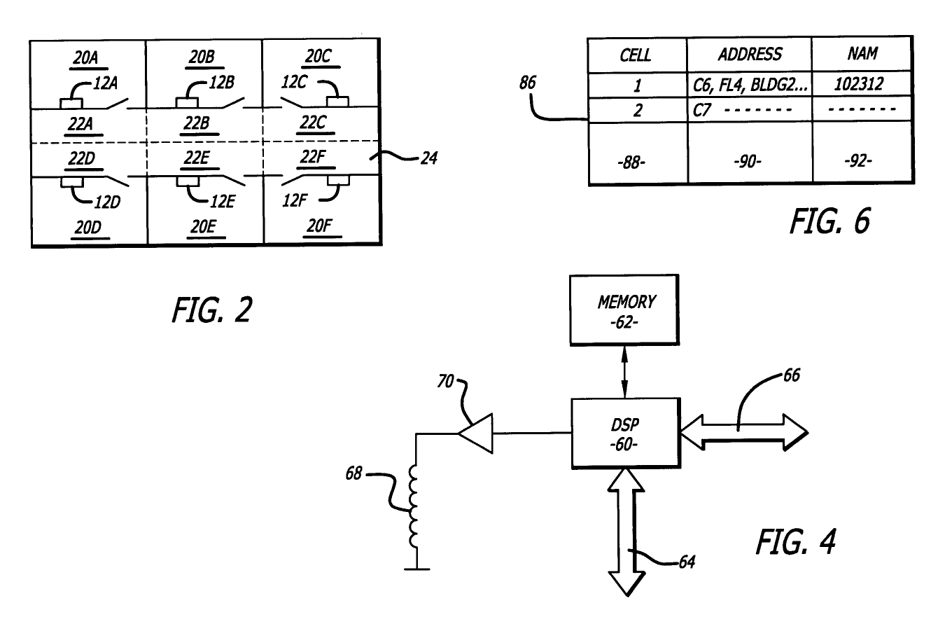

The locators 12 are mounted to the walls of a building structure and are thus in relative close proximity to the handset 18. The locators 12 create a number of pico or femto microcells for the cellular system. For example, as shown in FIG. 2, each office 20A-20F of a commercial building may include a locator 12A-12F. Each locator 12 is located within a microcell 22A-22F that includes the corresponding office and portion of a common hallway 24.

The handset 18 and locators 12 may operate in accordance with standard cell operation. For example, when the handset 18 moves from office 20A to office 20B the MSC 14 transfers the call from locator 12A to 12B. This can be done with standard strength of signal procedures. Because the number of locators 12 and corresponding microcells 22 for a given building may be burdensome for a conventional MSC 14, each building may have a dedicated MSC that hands off calls between the different locators. With such a system the building operators can provide a cellular phone system that is connected to a conventional hard wired PSTN carrier. The result may be lower cost and higher quality service. When the user's handset 18 is out of the range of the locators 12 the handset 18 can operate within a conventional cellular system by connecting with a base station in a conventional cellular cell.

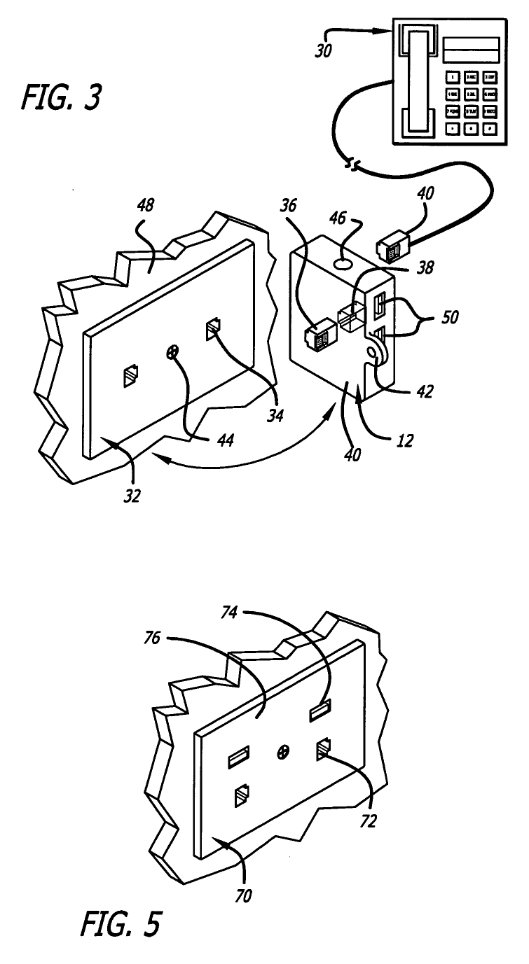

FIG. 3 shows an embodiment of a physical locator 12 that can also be connected to a peripheral device 30. By way of example the peripheral device may be a telephone, such as a voice over internet phone (“VOIP”). Although a phone is shown, it is to be understood that the device 12 may be a computer, PDA or other electronic device used for communication. The locator 12 may be mounted to a telephone outlet box 32. The outlet box 32 can be connected to a network (not shown). The network may be a PSTN, ISDN or other public telephone system. The network may also be, or include, a packet switched network such as the internet. With a packet switched network the phone 30 may be a VOIP device.

The outlet box 32 may include one or more female connectors 34. By way of example, the connectors 34 may be a RJ-11 or RJ-45 devices. The locator 12 includes a corresponding connector 36 that can be plugged into the outlet 32. The locator 12 may also have a female connector 38 that will receive a corresponding male connector 40 coupled to the phone 30. The connectors 38 and 40 may be attached to a locator housing 42. By way of example, the housing 42 may be constructed from a molded plastic material. The housing 42 may include a mounting ear 44 to allow the locator 12 to be mounted to the outlet box 32 by a fastener 44.

The locator 12 may include a power port 46 that can be connected to an external power source (not shown). The external power source may be required to power the internal circuits of the locator 12. By way of example, the external power source may include a transformer, rectifier, etc. that is commonly used to convert AC power to DC power for use in integrated circuits. Although a power port 46 is shown and described, it is to be understood that the network may provide power to the locator 12 through the connectors 34 and 36. The outlet box 32 is mounted to a wall 48 that has a physical address. For example, the wall may have a physical address of column C6, 4^{th} Floor, Building 2, 123 Main Street.

The locator 12 may include one or more additional connectors 50 attached to the housing 40. The connectors 50 can be attached to additional external devices (not shown). By way of example, the connectors 50 may be universal serial bus (USB) devices. The USB connectors can be connected to devices that support USB protocol such as computers and printers.

FIG. 4 is a schematic of the locator 12. The locator 12 may include a controller or processor 60 that is connected to memory 62. The processor 60 may be coupled to the peripheral device(s) such as a VIOP by bus 64 and network by bus 66. By way of example, the controller 60 may be a digital signal processor (DSP). Memory 62 may include volatile and/or non-volatile memory. For example, memory 62 may include static dynamic random memory (SRAM). Memory 62 may store instruction and data that is used by the controller 60 to perform one or more computations and/or routines. Memory 62 also stores a locator address that is unique to each locator and corresponds to the physical address of the outlet box. The locator address may be the same as the physical address. For example, the locator address may be column C6, 4^{th} Floor, Building 2, 123 Main St. in digital form. The locator address may be encrypted to prevent unauthorized reading of the address.

The locator 12 may include an antenna 68 coupled to the output RF power section of the transceiver DSP 60. The locator 12 may include a driver 70 to power the antenna 68. The antenna 66 may be attached to, embedded in, or otherwise coupled to the housing of the locator 12. The locator 12 may also contain ASIC circuits (not shown) to provide specific communication protocols such as GSM, TDMA and/or CDMA. The DSP 60 can process wireless communication from the handset 18 and retransmit the communication to the PSTN 16. Although a processor is shown and described, it is to be understood that the locator may have other logic circuits that perform the required functions. For example, the locator may have programmable logic such as decoders, etc. to perform the required functions.

Although a separate locator plugged into an outlet box is shown and described, it is to be understood that the locator can be integrated into an outlet box. It being understood that a separate locator module will be required to retrofit existing outlet boxes to include the locator function. New outlet boxes may contain the locator circuits etc. that are then mounted into building structures.

FIG. 5 shows an embodiment of a locator integrated into an outlet box. The box/locator 70 may have one or more female RJ-45 connectors 72 and may have one or more USB connectors 74 attached to a housing 76. The housing contains the locator circuits and the antennae. The circuits may be assembled into a modular assembly that can be snapped into and out of the housing 76. The backside of the box/locator 70 may be hardwired to the network and a power line. The locator circuits may include circuits to convert AC to DC power. Alternatively, the box/locator may have a power outlet that can be connected to an external AC/DC converter.

Referring to FIG. 1, each locator 12 may be coupled to a location information server (“LIS”) 80. The LIS 80 may be coupled to a public safety automatic location information (“PS-ALI”) server 82 through a packet switched network 84. The packet switched network 84 may be a wide area network such as the internet. The LIS 80 has a relational database that correlates an identifier of the handset 18 with the physical address of the locator 12 to provide the physical location of the handset 18. The identifier may be a NAM code that is unique to each handset 18. FIG. 6 provides an example of a LIS relational database 86 that includes a cell field 88, a physical address field 90 and a device identification NAM code field 92.

When a user places a phone call through the handset 18 the locator 12 retains the handset NAM code and sends a command to the LIS 80 to associate the code with the physical address of the locator 512. The command may include the NAM code and the stored locator address that are both transmitted to the LIS 80. Alternatively, the locator 12 may compare the NAM code with a NAM code(s) stored in memory. The locator 12 may send the command with the code and address only if the newly received NAM code is different from the stored code(s). This would indicate that a different handset recently became operational in the locator's cell. Additionally, the locator 12 may automatically transmit the NAM code and the locator address to the LIS 80 if the caller places a 9-1-1 call through the locator 12.

The NAM code and physical address can be uploaded to the cell phone provider network or directly to the PS-ALI server 82. The PS-ALI server 82 may also have a relational database that correlates the NAM code with the physical address of the locator 12. When the caller places an emergency 9-1-1 call the call is routed to a PSAP center. The center can determine the physical location of the caller from the data uploaded from the LIS 80 to the PS-ALI server 82. Such a means for locating a wireless caller is more accurate than conventional GPS systems which are unreliable in building structures and do not provide vertical information (eg. cannot distinguish between different floors of a building).

In operation a user will turn on a handset 18 which then tunes to a predetermined frequency on a control channel. The locator 12 may periodically transmit a system identification code (“SID”) that is received by the handset 18. The SID identifies the carrier that provides phone service through the locator 12. The handset 18 compares the transmitted SID with an internally stored SID code. If the SID codes match, the handset 18 transmits a NAM code. The NAM is a code that identifies the handset 18.

The locator 12 captures and forwards the NAM code and the stored locator address to the LIS 80. The LIS 80 stores the NAM of the handset 18 with the physical address of the locator 12 in the relational database. If the user moves to a different room the MSC 14 switches to the locator nearest the handset based on strength of signal. The new locator 12 may receive the NAM code from the handset 18. The new locator 12 sends a command and data to correlate the handset NAM with the physical address of the new locator 12 so that the relational database is updated to track the new location of the handset 18 and the caller. By way of example, referring to FIG. 6 if the handset with NAM code 102312 moved to cell 2 the handset would be associated with column 7 in the physical address field 90. Alternatively, the MSC 14 may also send a command to the LIS 80 to reconfigure the database so that the handset NAM is correlated with the physical address of the new locator.

The NAM and physical address data may also be uploaded to the PS-ALI server 82. If the user places a 9-1-1 call the PSAP center can specifically locate the room where the user is located by viewing the relational database in the PS-ALI server 80.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A locator for a wireless communication device that has a device identification, the locator can be coupled to an outlet box that is mounted to a wall and has a physical location, and coupled to a server that has a relational database that correlates the device identification with the physical location, comprising:
a housing that is coupled to the outlet box;
a transceiver that is coupled to said housing and wirelessly coupled to the wireless communication device to receive the device identification; and,
a circuit that is coupled to said transceiver and contains a stored locator address that corresponds to the physical location of the outlet box, said circuit transmits said stored locator address and the device identification to the server.

2. The locator of claim 1, wherein said circuit compares the device identification with a stored device identification and only transmits the device identification and said stored locator address if the device identification is different from said stored device identification.

3. The locator of claim 1, wherein said circuit transmits the device identification and said stored locator address if a 9-1-1 call is generated from the wireless communication device.

4. The locator of claim 1, wherein said circuit includes a processor and a memory.

5. The locator of claim 1, wherein said transceiver includes an antennae.

6. The locator of claim 1, further comprising an electrical connector attached to said housing and coupled to said circuit.

7. The locator of claim 6, wherein said electrical connector is a RJ-45 device.

8. The locator of claim 1, wherein said circuit retransmits wireless communication received from the wireless communication device.

9. A locator for a wireless communication device that has a device identification, the locator can be coupled to an outlet box that is mounted to a wall and has a physical location, and coupled to a server that has a relational database that correlates the device identification with the physical location, comprising:
a housing that is coupled to the outlet box;
a transceiver that is coupled to said housing and wirelessly coupled to the wireless communication device to receive the device identification; and,
circuit means for transmitting a stored locator address and the device identification to the server, said stored locator address corresponds to the physical location of the outlet box.

10. The locator of claim 9, wherein said circuit means compares the device identification with a stored device identification and only transmits the device identification and said stored locator address if the device identification is different from said stored device identification.

11. The locator of claim 9, wherein said circuit means transmits the device identification and said stored locator address if a 9-1-1 call is generated from the wireless communication device.

12. The locator of claim 9, wherein said circuit means includes a processor and a memory.

13. The locator of claim 9, wherein said transceiver includes an antennae.

14. The locator of claim 9, further comprising an electrical connector attached to said housing and coupled to said circuit.

15. The locator of claim 14, wherein said electrical connector is a RJ-45 device.

16. The locator of claim 9, wherein said circuit means retransmits wireless communication received from the wireless communication device.

17. A method for locating a wireless communication device that has a device identification with a locator that can be coupled to an outlet box that is mounted to a wall and has a physical location, the locator being coupled to a server that has a relational database that correlates the device identification with the physical location, comprising:
connecting a locator to the outlet box;
transmitting a wireless communication to the locator from the wireless communication device, the wireless communication including the device identification; and,
transmitting the device identification and a stored locator address from the locator to the server, the stored locator address corresponds to the physical address of the outlet box.

18. The method of claim 17, further comprising comparing the device identification with a stored device identification and transmitting the device identification and the stored locator address if the device identification does not match the stored device identification.

19. The method of claim 17, wherein the device identification and stored locator address are transmitted in response to the wireless communication device transmitting a 9-1-1 call.

20. The method of claim 17, wherein the locator retransmits the wireless communication.

21. An outlet box that is mounted to a wall and has a physical location, a wireless communication device that has a device identification, the outlet box being coupled to a server that has a relational database that correlates the device identification with the physical location, comprising:
a housing;
a transceiver that is coupled to said housing and wirelessly coupled to the wireless communication device to receive the device identification; and,
a circuit that is coupled to said transceiver and contains a stored locator address that corresponds to the physical location of the outlet box, said circuit transmits said stored locator address and the device identification to the server.

22. The outlet box of claim 21, wherein said circuit compares the device identification with a stored device identification and only transmits the device identification and said stored locator address if the device identification is different from said stored device identification.

23. The outlet box of claim 22, wherein said circuit transmits the device identification and said stored locator address if a 9-1-1 call is generated from the wireless communication device.

24. The outlet box of claim 21, wherein said circuit includes a processor and a memory.

25. The outlet box of claim 21, wherein said transceiver includes an antennae.

26. The outlet box of claim 21, further comprising an electrical connector attached to said housing and coupled to said circuit.

27. The outlet box of claim 26, wherein said electrical connector is a RJ-45 device.

28. The outlet box of claim 21, wherein said circuit retransmits wireless communication received from the wireless communication device.

29. An outlet box that is mounted to a wall and has a physical location, a wireless communication device that was a device identification, the locator being coupled to a server that has a relational database that correlates the device identification with the physical location, comprising:
a housing;
a transceiver that is coupled to said housing and wirelessly coupled to the wireless communication device to receive the device identification; and,
circuit means for transmitting a stored locator address and the device identification to the server, said stored locator address corresponds to the physical location of the outlet box.

30. The outlet box of claim 29, wherein said circuit means compares the device identification with a stored device identification and only transmits the device identification and said stored locator address if the device identification is different from said stored device identification.

31. The outlet box of claim 29, wherein said circuit means transmits the device identification and said stored locator address if a 9-1-1 call is generated from the wireless communication device.

32. The outlet box of claim 29, wherein said circuit means includes a processor and a memory.

33. The outlet box of claim 29, wherein said transceiver includes an antennae.

34. The outlet box of claim 29, further comprising an electrical connector attached to said housing and coupled to said circuit.

35. The outlet box of claim 34, wherein said electrical connector is a RJ-45 device.

36. The outlet box of claim 29, wherein said circuit retransmits wireless communication received from the wireless communication device.

37. A method for locating a wireless communication device that has a device identification with an outlet box that is mounted to a wall and has a physical location, the outlet box being coupled to a server that has a relational database that correlates the device identification with the physical location, comprising:
transmitting a wireless communication to the outlet box from the wireless communication device, the wireless communication including the device identification; and,
transmitting the device identification and a stored locator address from the outlet box to the server, the stored locator address corresponds to the physical address of the outlet box.

38. The method of claim 37, further comprising comparing the device identification with a stored device identification and transmitting the device identification and the stored locator address if the device identification does not match the stored device identification.

39. The method of claim 37, wherein the device identification and stored locator address are transmitted in response to the wireless communication device transmitting a 9-1-1 call.

40. The method of claim 37, wherein the outlet box retransmits the wireless communication.

41. A locator system for a wireless communication device that has a device identification, the system includes a locator that can be coupled to an outlet box that is mounted to a wall and has a physical location, comprising:
a location information server that contains a relational database, said relational database correlates the device identification with the physical location of the outlet box; and,
a locator that is connected to the outlet box, said locator receives a wireless communication from the wireless communication device that includes the device identification, said locator contains a stored locator address that corresponds to the physical location of the outlet box, and transmits said stored locator address and the device identification to said location information server.

42. The system of claim 41, wherein said locator compares the device identification with a stored device identification and only transmits the device identification and said stored locator address if the device identification is different from said stored device identification.

43. The system of claim 41, wherein said locator transmits the device identification and said stored locator address if a 9-1-1 call is generated from the wireless communication device.

44. The system of claim 41, wherein said locator includes a processor and a memory.

45. The system of claim 41, wherein said locator includes an antennae.

46. The system of claim 41, wherein said locator includes an electrical connector.

47. The system of claim 46, wherein said electrical connector is a RJ-45 device.

48. The system of claim 41, wherein said locator retransmits wireless communication received from the wireless communication device.

49. A locator system for a wireless communication device that has a device identification, the system includes a locator that can be coupled to an outlet box that is mounted to a wall and has a physical location, comprising:
a location information server that contains a relational database, said relational database correlates the device identification with the physical location of the outlet box; and,
locator means for receiving a wireless communication from the wireless communication device that includes the device identification, and transmitting a stored locator address and the device identification to said location information server, said stored locator address corresponds to the physical location of the outlet box.

50. The system of claim 49, wherein said locator means compares the device identification with a stored device identification and only transmits the device identification and said stored locator address if the device identification is different from said stored device identification.

51. The system of claim 49, wherein said locator means transmits the device identification and said stored locator address if a 9-1-1 call is generated from the wireless communication device.

52. The system of claim 49, wherein said locator means includes a processor and a memory.

53. The system of claim 49, wherein said locator means includes an antennae.

54. The system of claim 49, wherein said locator means includes an electrical connector.

55. The system of claim 54, wherein said electrical connector is a RJ-45 device.

56. The system of claim 49, wherein said locator means retransmits wireless communication received from the wireless communication device.

57. A method for locating a wireless communication device that has a device identification with a locator that can be coupled to an outlet box that is mounted to a wall and has a physical location, the locator being coupled to a location information server that has a relational database that correlates the device identification with the physical location, comprising:
connecting a locator to the outlet box;
transmitting a wireless communication to the locator from the wireless communication device, the wireless communication including the device identification;
transmitting the device identification and a stored locator address from the locator to the location information server, the stored locator address corresponds to the physical address of the outlet box; and,
correlating the device identification with the physical location within the relational database.

58. The method of claim 57, further comprising comparing the device identification with a stored device identification and transmitting the device identification and the stored locator address if the device identification does not match the stored device identification.

59. The method of claim 57, wherein the device identification and stored locator address are transmitted in response to the wireless communication device transmitting a 9-1-1 call.

60. The method of claim 57, wherein the locator retransmits the wireless communication.

61. A locator system for a wireless communication device that has a device identification, the system includes an outlet box that is mounted to a wall and has a physical location, comprising:
a location information server that contains a relational database, said relational database correlates the device identification with the physical location of the outlet box; and,
an outlet box that receives a wireless communication from the wireless communication device that includes the device identification, said outlet box contains a stored locator address that corresponds to the physical location of said outlet box, and transmits said stored locator address and the device identification to said location information server.

62. The system of claim 61, wherein said outlet box compares the device identification with a stored device identification and only transmits the device identification and said stored locator address if the device identification is different from said stored device identification.

63. The system of claim 61, wherein said outlet box transmits the device identification and said stored locator address if a 9-1-1 call is generated from the wireless communication device.

64. The system of claim 61, wherein said outlet box includes a processor and a memory.

65. The system of claim 61, wherein said outlet box includes an antennae.

66. The system of claim 61, wherein said outlet box includes an electrical connector.

67. The system of claim 66, wherein said electrical connector is a RJ-45 device.

68. The system of claim 61, wherein said outlet box retransmits wireless communication received from the wireless communication device.

69. A locator system for a wireless communication device that has a device identification, the system includes an outlet box that is mounted to a wall and has a physical location, comprising:
a location information server that contains a relational database, said relational database correlates the device identification with the physical location of the outlet box; and,
outlet box means for receiving a wireless communication from the wireless communication device that includes the device identification, and transmitting a stored locator address and the device identification to said location information server, said stored locator address corresponds to the physical location of the outlet box.

70. The system of claim 69, wherein said outlet box means compares the device identification with a stored device identification and only transmits the device identification and said stored locator address if the device identification is different from said stored device identification.

71. The system of claim 69, wherein said outlet box means transmits the device identification and said stored locator address if a 9-1-1 call is generated from the wireless communication device.

72. The system of claim 69, wherein said outlet box means includes a processor and a memory.

73. The system of claim 69, wherein said outlet box means includes an antennae.

74. The system of claim 69, wherein said outlet box means includes an electrical connector.

75. The system of claim 74, wherein said electrical connector is a RJ-45 device.

76. The system of claim 70, wherein said outlet box means retransmits wireless communication received from the wireless communication device.

77. A method for locating a wireless communication device that has a device identification with an outlet box that is mounted to a wall and has a physical location, the locator being coupled to a location information server that has a relational database that correlates the device identification with the physical location, comprising:
transmitting a wireless communication to the outlet box from the wireless communication device, the wireless communication including the device identification;
transmitting the device identification and a stored locator address from the outlet box to the location information server, the stored locator address corresponds to the physical address of the outlet box; and,
correlating the device identification with the physical location within the relational database.

78. The method of claim 77, further comprising comparing the device identification with a stored device identification and transmitting the device identification and the stored locator address if the device identification does not match the stored device identification.

79. The method of claim 77, wherein the device identification and stored locator address are transmitted in response to the wireless communication device transmitting a 9-1-1 call.

80. The method of claim 77, wherein the outlet box retransmits the wireless communication.
